(19) United States
(12) Patent Application Publication
(10) Pub. No.: US 2004/0129309 A1
(43) Pub. Date: Jul. 8, 2004

(54) Pneumatic wheel and tire overpressure protection method and apparatus

(76) Inventors: Mark T. Eckert, Troy, OH (US); Steven C. Campbell, Dayton, OH (US)

Correspondence Address: David Ronyak, The B.F. Goodrich Co., Patent Law Dept., 9921 Bercksville Rd., Bracksville, OH, 44141-3289, US

(21) Appl. No.: 10/337,459

(22) Filed: Jan. 7, 2003

(51) Int. Cl. F16K 17/14

(52) U.S. Cl. 137/72

(57) ABSTRACT

A pneumatic wheel and tire assembly equipped with a brake heat sink is protected from overpressure due to increased internal inflation gas temperature, caused by increased temperature of the brake heat sink, by installing a thermally activated fuse plug having a fuse in the wheel structure such that the fuse extends beyond the wheel structure towards the brake heat sink.

### BACKGROUND

The present invention is in the field of pneumatic wheel and tire overpressure protection. More specifically this invention relates to a wheel and tire assembly equipped with a brake comprising a brake structure and a brake heat sink; and protection from overpressure due to increased internal inflation gas temperature caused by increased temperature of the brake's heat sink.

Fuse plug pressure relief valves are well known in the art as a means of protection from overpressure due to increased internal inflation gas temperature caused by increased temperature of a brake's heat sink. In general, fuse plugs incorporate a eutectic material that phase transforms from solid to liquid state at a given temperature. In a wheel assembly, after the eutectic material of the fuse plug phase transforms to a liquid state, the tire pressure expels the liquefied eutectic material, thus releasing the tire pressure. These fuse plugs are installed in the wheel structure such that they are essentially flush with the inner wheel structure surface. Thus heat is generated in the brake's heat sink, and must be conducted through the wheel structure, convected through the inflation gas, and/or radiated from the brake's heat sink to the fuse plug. It takes time for this heat transfer from the heat source (the brake's heat sink) to the fuse plug. Under certain conditions, non-uniform heating of the wheel can cause areas of reduced wheel strength that if left unattended could result in wheel failure. Thus due to the time it takes for the heat transfer from the source to the fuse plug, it is possible to cause adverse heating in the wheel, reducing wheel strength, while never activating the overpressure relief. This can be very dangerous as aircraft tire “cold” inflation pressures are commonly 200 psi or more. If wheel failure occurs at these pressures, flying wheel and tire fragments can cause serious damage to the aircraft, such as damage or destruction of the turbine engines, and wings, including fuel cells in the wings.

In order to solve these problems, a method and apparatus of overpressure protection is desired whereby the pressure release valve would be more responsive to the temperature of the associated brake heat sink, and thus reduce the time to pressure release. This would reduce the temperature reached by the inflation gas within the tire, and therefore reduce the pressure, and allow for the structural design of the wheel assembly to reflect this lower pressure and temperature. This would allow for lighter wheels.

### SUMMARY OF THE INVENTION

A method for protecting a pneumatic wheel and tire assembly from overpressure, where the wheel is equipped with a brake heat sink, and wherein overpressure is due to increased internal inflation gas temperature caused by increased temperature of the brake heat sink. This method comprises installing a thermally activated fuse plug having a fuse, in the wheel structure such that the fuse extends beyond the wheel structure towards the brake heat sink.

### BRIEF DESCRIPTION OF THE DRAWINGS

FIG. 1 is a cross-section view of a pneumatic wheel and brake assembly according to an aspect of the invention.

FIG. 2 is a cross-sectional view of a thermally activated fuse plug, according to an aspect of the invention.

FIG. 3 is a front view of a wheel structure according to an aspect of the invention.

FIG. 4 is a cross-sectional view of a pneumatic wheel and brake assembly according to an aspect of the invention.

### DETAILED DESCRIPTION

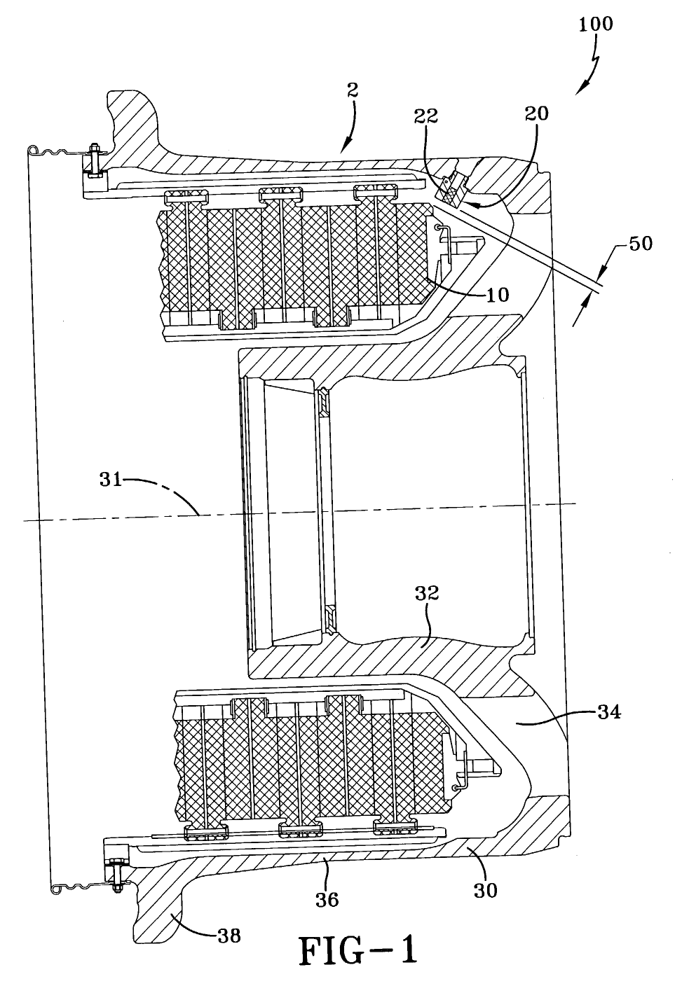

Various aspects of the invention are presented in FIGS. 1-4 which are not drawn to scale and in which like components are numbered alike. Referring now to FIGS. 1-3, according to an aspect of the invention, a method for protecting a pneumatic wheel and tire assembly 3 from overpressure, wherein the wheel 2 comprises a wheel structure 30, and is equipped with a brake heat sink 10, wherein overpressure is due to increased internal inflation gas temperature caused by increased temperature of the brake heat sink 10, comprises installing a thermally activated fuse plug 20 having a fuse 22, in the wheel structure 30 such that the fuse 22 extends beyond the wheel structure 30 towards the brake heat sink 10. When a wheel is equipped with a brake, it is referred to collectively as a wheel and brake assembly 100. Extending the fuse plug 20 towards the brake heat sink 10 moves the fuse 22 closer to the brake heat sink and allows the fuse 22 to be more responsive to the brake heat sink 10 temperature. A wheel structure 30 typically comprises a hub 32, a web 34, a tube well 36, and a rim 38. The fuse plug 20 is typically installed in the radius between the web 34 and the tube well 36. This is a thicker portion of the wheel structure 30, and therefore structurally able to accommodate the installation of a fuse plug 20. Extending the fuse plug 20 allows the fuse 22 to be more responsive to the brake heat sink 10 temperature, while not requiring any structural changes to the design of the wheel structure 30.

According to a further aspect of the invention, the fuse 22 is proximate to the brake heat sink 10. The closer the fuse 22 gets to the brake heat sink 10, the more responsive it is to brake heat sink 10 temperature, although at some point it could be too responsive. If the fuse 22 is too responsive to the brake heat sink 10 temperature, it could activate on normal landing. Therefore the distance 50 between the brake heat sink 10 and the fuse 22 would be determined on a case-by-case basis by the geometry of the wheel and tire assembly and sensitivity analysis, to fine-tune the desired fuse 22 temperature rise response to brake heat sink 10 thermal input. Thus for optimum performance, this distance would be designed for each individual application, ideally by a full-scale test of the wheel and tire assembly. For an aircraft application, a full-scale test would be conducted, where the brake energy is dictated by the aircraft manufacturer. According to a further aspect of the invention, the distance 50 between the fuse 22 and the brake heat sink 10 is approximately ¼ inch. This is just one dimension which has been used and tested with good results, as discussed above this dimension could vary from application to application. This invention is in no way limited to aircraft application. Any application where tire overpressure due to overheating is a concern could benefit from this invention. For instance truck wheel and tire assemblies, and earthmover wheel and tire assemblies are two other potential applications.

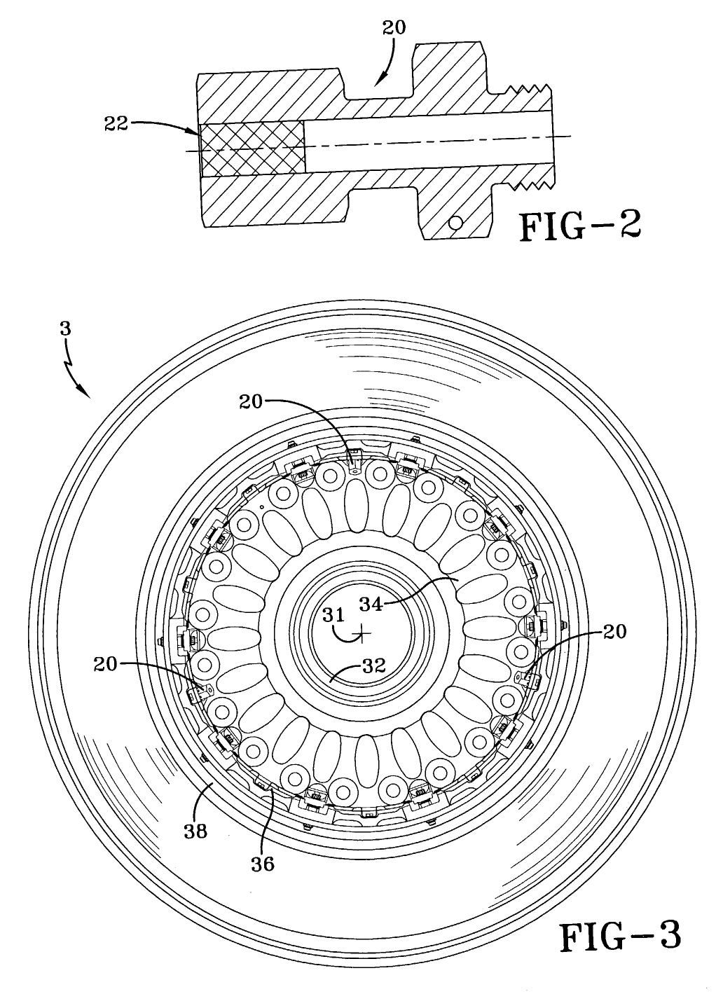

Referring to FIG. 3, in a preferred embodiment, there are multiple fuse plugs 20 per protected wheel and tire assembly 3. In this embodiment, the fuse plugs 20 are spaced circumferentially about the wheel structure. For optimum performance, placement of multiple fuse plugs would be designed for each individual application, ideally by a full-scale test of the wheel and tire assembly. One such placement would be with three fuse plugs 20; one fuse plug 20 at the 4:00 position, one at the 8:00 position, and one at the 12:00 position with respect to the center of the wheel. Other applications may require more or less fuse plugs, equally spaced about the wheel structure.

In a preferred embodiment of the invention, the fuse 22 is a eutectic material. This is just one common example of a thermally activated fuse, and in no way is intended to limit the invention to the use of a eutectic material. Any suitable thermally activated fuse is considered within the purview of this invention, and forms no independent part of the invention.

According to a further aspect of the invention, a pneumatic wheel and tire assembly 3 has a wheel 2, wherein the wheel has a wheel structure 30 and is equipped with a brake heat sink 10. A thermally activated fuse plug 20 is installed in the wheel structure 30, wherein the thermally activated fuse plug 20 has a thermally activated fuse 22. The improvement comprises extending the thermally activated fuse 22 beyond the wheel structure 30 towards the brake heat sink 10.

According to a further aspect of the invention, a method of increasing responsiveness of a thermally activated fuse plug 20 to brake heat sink 10 temperature in a pneumatic wheel and tire assembly 3 comprises installing the thermally activated fuse plug 20 having a fuse 22, in the wheel structure 30 such that the fuse 22 extends beyond the tube well 30 towards the brake heat sink 10.

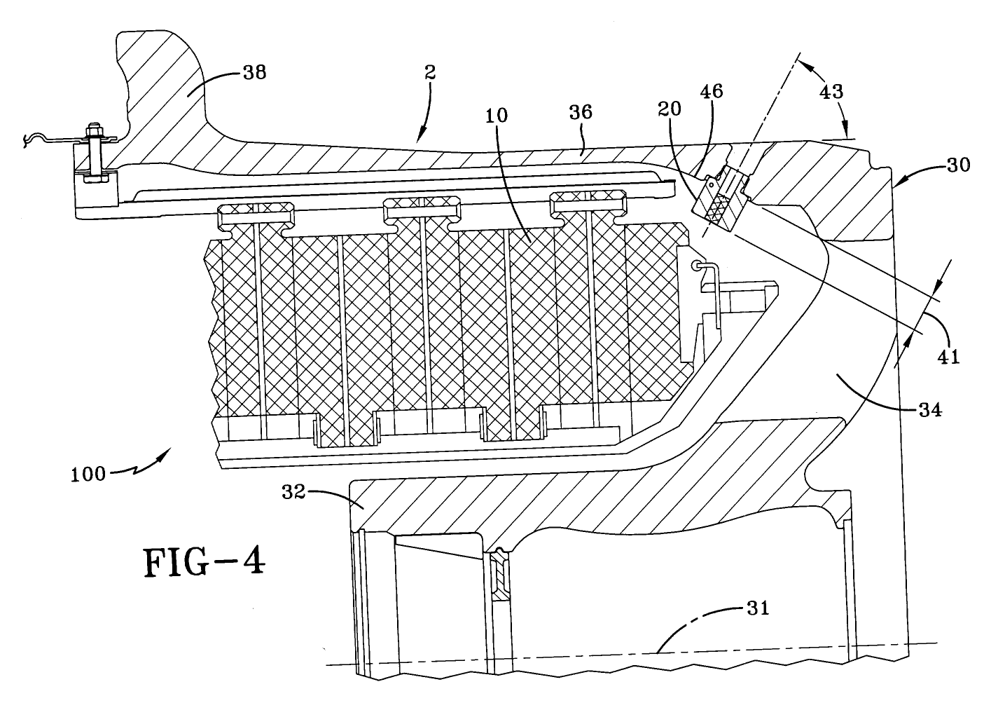

Referring now to FIG. 4, according to another aspect of the invention, a wheel structure 30 for use in a pneumatic wheel and tire assembly 3 wherein the wheel has a wheel structure 30 and an axis of rotation 31 comprises, a hub 32, a web 34 extending normally from the hub 32, a tube well 36, an elongated fuse plug 20 having a fuse 22, and a rim 38. The tube well 36 extends normally from the web 34, such that there is a transition radius 46 from the web 34 to the tube well 36. The elongated fuse plug 20 is installed in the radius 46, such that the elongated fuse plug 20 extends the fuse 22 away from the radius 46 towards the axis of rotation 31. According to a further aspect of the invention, the elongated fuse plug 20 extends away from the radius 46 at approximately a 45 degree angle 43 to the tube well 36.

In a further embodiment, when the wheel is equipped with a brake heat sink 10, the elongated fuse plug 20 extends the fuse 22 away from the radius 46 and towards the brake heat sink 46.

In a further embodiment, the elongated fuse plug 20 extends the fuse 22 away from the radius 46 at least ½ inch, towards the brake heat sink 10. In a further embodiment, the elongated fuse plug 20 extends the fuse 22 away from the radius 46 at least ¾ inch, towards the brake heat sink 10. The distance 41 which the elongated fuse plug 20 extends the fuse 22 away from the radius 46 would be determined on a case-by-case basis by the geometry of the wheel and tire assembly and sensitivity analysis, to fine-tune the desired fuse 22 temperature rise response to brake heat sink 10 thermal input. Thus for optimum performance, this distance would be designed for each individual application, ideally by a full-scale test of the wheel and brake assembly. For an aircraft application, a full-scale test would be conducted, where the brake energy is dictated by the aircraft manufacturer. In a preferred embodiment, the elongated fuse plug 20 extends away from the radius 46 such that there is a distance 50 between the fuse 22 and the brake heat sink 10 of approximately ¼ inch.

The disclosed invention thus allows the overpressure protection to be more responsive to brake heat sink temperature, reducing the temperature reached by the wheel structure 30, without requiring structural changes to the design of the wheel structure 30.

What is claimed is:

1. A method for protecting a pneumatic wheel and tire assembly from overpressure, wherein the wheel and is equipped with a brake heat sink, and wherein overpressure is due to increased internal inflation gas temperature caused by increased temperature of the brake heat sink, and wherein the wheel comprises a wheel structure, comprising:
installing a thermally activated fuse plug having a fuse, in the wheel structure such that said fuse plug extends said fuse beyond the wheel structure towards the brake heat sink.

2. The method of claim 1 wherein said fuse is proximate to the brake heat sink.

3. The method of claim 1 wherein there is a distance between said fuse and said brake heat sink of approximately ¼ inch.

4. The method of claim 1 further comprising installing additional thermally activated fuse plugs, spaced circumferentially about said wheel structure.

5. The method of claim 1 wherein said fuse is a eutectic material.

6. The method of claim 1 wherein the wheel structure comprises a hub; a web; a tube well, wherein said wheel structure forms a radius between said web and said tube well; and a rim, and wherein said fuse plug is installed in the radius between said web and said tube well.

7. In a pneumatic wheel and tire assembly wherein the wheel has a wheel structure and is equipped with a brake heat sink, and wherein a thermally activated fuse plug is installed in the wheel structure, wherein the thermally activated fuse plug has a thermally activated fuse, the improvement comprising:
extending said thermally activated fuse beyond the wheel structure towards the brake heat sink.

8. The pneumatic wheel and tire assembly of claim 7 wherein said fuse is proximate to said brake heat sink.

9. The pneumatic wheel and tire assembly of claim 7 wherein there is a distance between said fuse and said brake heat sink of approximately 1/4 inch.

10. The pneumatic wheel and tire assembly of claim 7 further comprising installing additional thermally activated fuse plugs, spaced around said wheel structure.

11. The pneumatic wheel and tire assembly of claim 7 wherein said fuse is a eutectic material.

12. A method of increasing responsiveness of a thermally activated fuse plug to brake heat sink temperature in a pneumatic wheel and tire assembly wherein the wheel has a wheel structure and is equipped with a brake heat sink, wherein the thermally activated fuse plug has a thermally activated fuse, comprising installing the thermally activated fuse plug in the wheel structure such that the fuse plug extends beyond the wheel structure towards the brake heat sink.

13. The method of claim 12 wherein said fuse plug is proximate to said brake heat sink.

14. The method of claim 12 wherein there is a distance between said fuse plug and said brake heat sink of approximately ¼ inch.

15. The method of claim 12 wherein said fuse is a eutectic material.

16. A wheel structure for use in a pneumatic wheel and tire assembly wherein the wheel comprises said wheel structure and has an axis of rotation, comprising;
a hub;
a web, extending normally from said hub;
a tube well extending normally from said web, such that there is a transition radius from said web to said tube well; and,
an elongated fuse plug, having a fuse, wherein said elongated fuse plug is installed in said radius, such that said elongated fuse plug extends said fuse away from said radius, towards the axis of rotation; and,
a rim.

17. The wheel structure of claim 16 wherein the wheel is equipped with a brake heat sink, and wherein said elongated fuse plug extends said fuse away from said radius, towards the brake heat sink.

18. The wheel structure of claim 17 wherein said elongated fuse plug extends said fuse away from said radius at least ½ inch, towards the brake heat sink.

19. The wheel structure of claim 17 wherein said elongated fuse plug extends said fuse away from said radius at least ¾ inch, towards the brake heat sink.

20. The wheel structure of claim 17 wherein said elongated fuse plug extends said fuse away from said radius such that there is a distance between said fuse said brake heat sink of approximately ¼ inch.

21. The wheel structure of claim 16 wherein said elongated fuse plug extends away from said radius at approximately a 45-degree angle to said tube well.
